(19) United States
(12) Patent Application Publication
(10) Pub. No.: US 2024/0010126 A1
(43) Pub. Date: Jan. 11, 2024

(54) METHOD AND SYSTEM FOR GENERATING SURROUND VIEW IMAGE OF TRAILER VEHICLE

(71) Applicant: UBIQ MICRO SYSTEMS, Suwon-si (KR)

(72) Inventor: Cheol Jin PARK, Hwaseong-si (KR)

(73) Assignee: UBIQ MICRO SYSTEMS, Suwon-si (KR)

(21) Appl. No.: 18/370,680

(22) Filed: Sep. 20, 2023

Related U.S. Application Data
(63) Continuation of application No. PCT/KR2022/000565, filed on Jan. 12, 2022.

(30) Foreign Application Priority Data
Mar. 22, 2021 (KR) 10-2021-0036650

(51) Int. Cl. B60R 1/00; B60R 1/26

(52) U.S. Cl. CPC B60R 1/002; B60R 1/26; B60R 2300/102; B60R 2300/105

(57) ABSTRACT

A method for generating a surround view image of a trailer vehicle is proposed. The method includes receiving, by an image processing device of a tractor, first calibration information for a plurality of cameras arranged on a first trailer from an image processing device arranged on the first trailer, receiving, by the image processing device of the tractor, trailer image information comprising images captured by the plurality of cameras of the first trailer from the first trailer, generating, by the image processing device of the tractor, tractor image information comprising images captured by a plurality of cameras arranged on the tractor and generating, by the image processing device of the tractor, the surround view image of the trailer vehicle using the trailer image information, the tractor image information, and the first calibration information.

### CROSS REFERENCE TO RELATED APPLICATION

This application claims the benefit under 35 U.S.C. § 119(a) of Korean Patent Application No. 10-2021-0036650, filed on May 22, 2021, in the Korean Intellectual Property Office and, the entire disclosure of which is incorporated herein by reference for all purposes.

### BACKGROUND

### 1. Field

The following description relates to a method and system for generating a surround view image of a trailer vehicle.

### 2. Description of the Related Art

A trailer vehicle may be provided with a monitoring system to prepare for safety accidents that may occur during transportation or unloading. Such a monitoring system may capture images around the trailer vehicle by using a plurality of cameras, synthesize the images centered on the trailer vehicle, and provide a surround view image. Accordingly, the monitoring system may prevent safety accidents by detecting people or objects that may present outside of a vehicle driver's field of vision.

In a trailer vehicle, a trailer that is connected to the rear of a tractor may be replaced by a different trailer as required. The different trailer being replaced may have different dimensions (i.e., a length, a width, and a height) than those of a previous trailer. In addition, even though the different trailer being replaced has the same dimensions as those of the previous trailer, positions or specifications of cameras arranged on the different trailer may be different. In this case, when a monitoring system of the trailer vehicle generates a surround view image by applying the same settings as before, distortion may occur in the image. Accordingly, as for the monitoring system, technology is required to automatically correct distortion that occurs during image synthesis even though a trailer is replaced by another trailer.

### SUMMARY

In one general aspect, there is provided a method for generating a surround view image of a trailer vehicle, the method including: receiving, by an image processing device of a tractor, calibration information for a plurality of cameras arranged on a first trailer from an image processing device arranged on the first trailer, receiving, by the image processing device of the tractor, trailer image information comprising images captured by the plurality of cameras of the first trailer from the first trailer, generating, by the image processing device of the tractor, tractor image information comprising images captured by a plurality of cameras arranged on the tractor and generating, by the image processing device of the tractor, the surround view image of the trailer vehicle using the trailer image information, the tractor image information, and the calibration information.

In another aspect, there is provided a system for generating a surround view image for a trailer vehicle, the system including: a plurality of cameras arranged on a first trailer, a trailer image processing device arranged on the first trailer, and configured to generate trailer image information for the first trailer by receiving images captured by the plurality of cameras of the first trailer and store calibration information for the plurality of cameras, a plurality of cameras arranged on a tractor, and a tractor image processing device arranged on the tractor, and configured to receive the trailer image information and the calibration information from the trailer image processing device, and generate the surround view image of the trailer vehicle using the trailer image information and the calibration information, and tractor image information generated by using images captured by the plurality of cameras of the tractor.

### BRIEF DESCRIPTION OF THE DRAWINGS

FIG. 1 is an example of a system for generating a surround view image from a trailer vehicle.

FIG. 2 is an example of a flowchart for a process of generating a surround view image of a trailer vehicle.

FIG. 3 is an example of the system for generating the surround view image of the trailer vehicle.

FIG. 4 is an example illustrating a case in which a trailer is connected to a tractor.

FIG. 5 is an example of image information generated by an image processing device provided in the tractor.

FIG. 6 is an example of image information generated by an image processing device provided in the trailer.

FIG. 7 is an example illustrating a synthesized surround view image.

FIG. 8 is an example illustrating a surround view image when the trailer vehicle turns.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

As used herein, the term “and/or” includes any one and any combination of any two or more of the associated listed items.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

A trailer vehicle refers to a vehicle in which a trailer and a tractor are connected to each other. The trailer may take various forms depending on the amount or type of goods to be loaded. The tractor is a driving vehicle for towing the trailer.

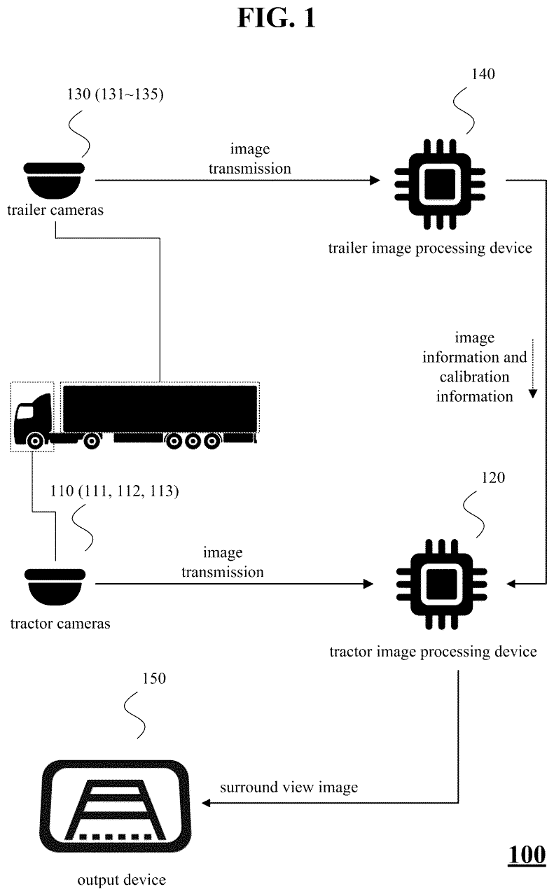

FIG. 1 is an example of a system 100 for generating a surround view image from a trailer vehicle. The system 100 for generating the surround view image of the trailer vehicle may include: tractor cameras 110 and a tractor image processing device 120, which are arranged on a tractor; trailer cameras 130 and a trailer image processing device 140, which are arranged on a trailer; and an output device 150. The tractor cameras 110 are arranged on the tractor, and may be a plurality of cameras arranged at positions different from each other. The trailer cameras 130 are arranged on the trailer, and may be a plurality of cameras arranged at positions different from each other.

Each of the tractor image processing device 120 and the trailer image processing device 140 refers to a device capable of processing images in a predetermined manner. For example, each of the tractor image processing device 120 and the trailer image processing device 140 may be an electronic control unit (ECU) arranged in a vehicle. Alternatively, each of the tractor image processing device 120 and the trailer image processing device 140 may be a processor for image processing.

The trailer image processing device 140 may receive images captured from a plurality of cameras 131 to 135 provided on a trailer. Each of the plurality of trailer cameras 131 to 135 may be installed at a predetermined position to generate a surround view image of the trailer. For example, the plurality of cameras provided on the trailer may be five-channel cameras of which the two cameras are arranged on the right side, two cameras are arranged on the left side, and one camera is arranged on the rear of the trailer. The trailer image processing device 140 may generate trailer image information on the basis of a plurality of images respectively transmitted from the plurality of cameras. The trailer image information may be a surround view image, which is for the trailer and generated on the basis of images received by the trailer image processing device. Alternatively, the trailer image information may be composed of images synchronized, according to a photographing time, with images received from the respective cameras arranged on the trailer.

In addition, the trailer image processing device 140 may collect calibration information for the plurality of cameras provided on the trailer. Here, the calibration information may include at least one of an installation position, a photographing angle, a photographing direction, and a trailer turning angle for each of the plurality of cameras provided on the trailer. The calibration information may be used to correct distortion when a surround view image of the entire trailer vehicle is generated.

The tractor image processing device 120 may receive images captured by a plurality of cameras 111 to 113 provided on a tractor. Each of the plurality of tractor cameras 111 to 113 may be installed at a predetermined position to generate a surround view image of the tractor. For example, the plurality of cameras provided on the tractor may be three-channel cameras of which the one camera is arranged on the right side, one camera is arranged on the left side, and one camera is arranged on the rear of the tractor.

The tractor image processing device 120 may generate tractor image information for the tractor by using images captured by the plurality of cameras provided on the tractor. In this case, the tractor image information may be a surround view image, which is for the tractor and generated on the basis of images collected by the cameras of the tractor. Alternatively, the tractor image information may be composed of images synchronized, according to a photographing time, with images received from respective cameras arranged on the tractor.

The tractor image processing device 120 may receive the trailer image information and the calibration information from the trailer image processing device 140. The tractor image processing device and the trailer image processing device may be connected wired or wirelessly when the tractor and trailer are connected to each other.

The tractor image processing device 120 may generate a surround view image of the entire vehicle by synthesizing the surround view image around the tractor and the surround view image around the trailer received from the trailer image processing device 140. In this case, the tractor image processing device 120 may synthesize the surround view image of the entire vehicle by using the calibration information received from the trailer image processing device 140.

Furthermore, the tractor image processing device 120 may generate a surround view image of the entire vehicle by using synchronized images captured by the tractor cameras and synchronized trailer-surrounding images received from the trailer image processing device 140. In this case, the tractor image processing device 120 may synthesize a surround view image of the entire vehicle by using the calibration information received from the trailer image processing device 140.

The tractor image processing device 120 may generate one image encompassing 360 degrees around the entire vehicle by using the trailer image information and the tractor image information received from the trailer image processing device 140. While generating the entire surround view image, the tractor image processing device 120 may concatenate overlapping areas or boundaries to synthesize the entire surround view image.

The tractor image processing device 120 may transmit the entire synthesized surround view image to an output device 150. The output device 150 may output the surround view image around the vehicle. The output device 150 may be a display device arranged on a vehicle front panel.

The trailer may be replaced on the tractor. In a case where a replaced trailer has a size different from that of the previous trailer or information (i.e., photographing angles, installation positions, etc.) of the cameras arranged on the replaced trailer is different, distortion occurs in a surround view image when the tractor image processing device 120 synthesizes the surround view image by using image information transmitted by the trailer image processing device 140 based on the same standard as before.

In order to prevent such a problem, the tractor image processing device 120 may correct the distortion of the surround view image generated according to the calibration information received from the trailer image processing device 140, or may synthesize a surround view image without distortion on the basis of the calibration information received from the trailer image processing device 140.

The calibration information includes information on installation positions, photographing angles, and photographing directions of the cameras installed on the trailer. Accordingly, the tractor image processing device 120 may generate the surround view image without distortion by using the received calibration information.

Furthermore, the calibration information may also include information on turning angles of the trailer. As the trailer vehicle travels, the tractor and the trailer may form a certain angle depending on a direction of travel. In this case, the tractor image processing device 120 may generate a surround view image with less distortion by further using the turning angles of the trailer.

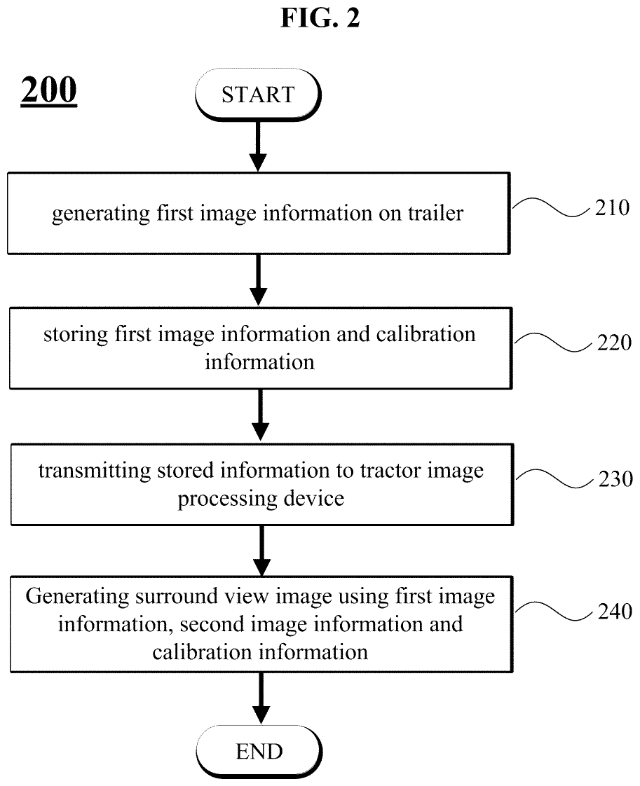

FIG. 2 is a flowchart illustrating a method for generating a surround view image of a trailer vehicle according to an exemplary embodiment of the disclosed technology. Referring to FIG. 2, the method 200 for generating the surround view image is performed by two image processing devices provided in the trailer vehicle. As previously described with reference to FIG. 1, the image processing device provided in a trailer is referred to as a trailer image processing device, and the image processing device provided in a tractor is referred to as a tractor image processing device.

In step 210, the trailer image processing device generates trailer image information on the trailer by receiving images captured by a plurality of cameras provided on the trailer. The trailer image information generated by the trailer image processing device may include the trailer's surround view image generated from a plurality of images or an image synchronized with the images captured by the trailer cameras.

In step 220, the trailer image processing device stores the trailer image information and the calibration information for the plurality of cameras. The calibration information includes at least one of an installation position, a photographing angle, a photographing direction, and a trailer turning angle for each of the plurality of cameras provided on the trailer. The trailer image processing device may collect the information on the installation position, photographing angle, and photographing direction of each camera at an initial stage of installation to include this information in the calibration information. The trailer image processing device may detect a turning angle when the trailer vehicle turns and include the detected turning angle in the calibration information. The trailer image processing device receives detection values by using a separate sensor to detect turning angles of the trailer vehicle, and may store the calibration information.

In step 230, the tractor image processing device communicates with the trailer image processing device and receives the trailer image information and the calibration information. When the tractor and the trailer are connected to each other, the tractor image processing device may automatically receive the trailer image information and the calibration information from the trailer image processing device through wired or wireless communication.

In step 240, the tractor image processing device generates tractor image information on the tractor by using images captured by the plurality of cameras provided on the tractor. In addition, the tractor image processing device generates a surround view image by using the trailer image information and the tractor image information. The tractor image processing device generates an entire surround view image of the trailer vehicle.

The trailer image processing device may generate the surround view image (i.e., the trailer image information) with image information on the trailer, and the tractor image processing device may generate the entire surround view image by merging the received trailer image information and the tractor surround view image collected by the tractor image processing device itself.

The trailer image processing device may synchronize the images (i.e., the trailer image information) collected by the trailer cameras, and the tractor image processing device may generate an entire surround view image by using the received trailer image information and the tractor surround view images collected by the tractor image processing device itself.

The tractor image processing device may correct distortion of the surround view image according to the calibration information. The tractor image processing device may generate an entire surround view image without distortion based on the trailer image information, the tractor image information and the calibration information. The tractor image processing device may calibrate the trailer image information with the tractor image information to generate the entire surround view.

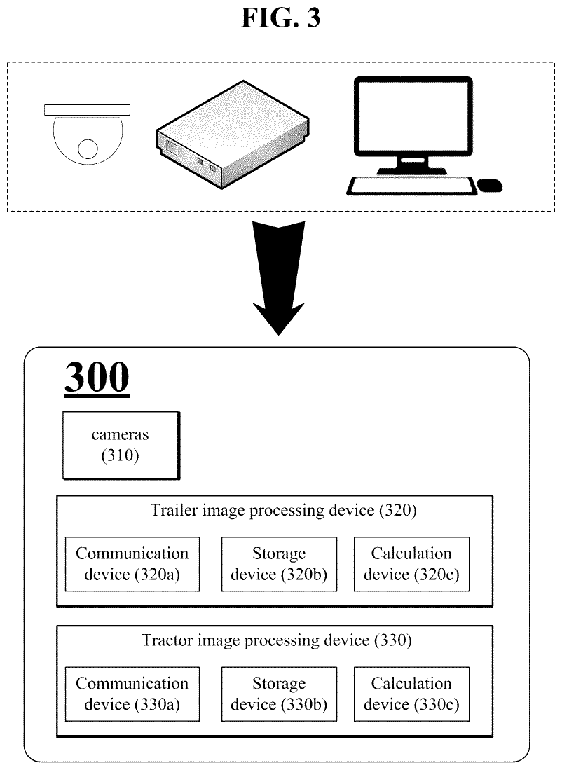

FIG. 3 is a block diagram illustrating a system for generating a surround view image of a trailer vehicle according to an exemplary embodiment of the disclosed technology. Referring to FIG. 3, the system 300 for generating the image includes cameras 310, a trailer image processing device 320, and a tractor image processing device 330. In addition, the trailer image processing device 320 includes a communication device 320a, a storage device 320b, and a calculation device 320c. In addition, in the same manner, the tractor image processing device 330 includes a communication device 330a, a storage device 330b, and a calculation device 330c.

A plurality of cameras 310 may be arranged on the surrounding sides of the trailer vehicle. The plurality of cameras may use optical cameras commonly used for image photographing. Fundamentally, a camera may be installed on each of the front, rear, and left and right sides of the vehicle in order to generate a surround view image encompassing 360 degrees centered on the trailer vehicle. However, unlike general passenger cars, the trailer vehicle is a special vehicle that is a combination of a tractor and a trailer, so the plurality of cameras may be provided on the left and right sides of the trailer vehicle. For example, one camera may be provided on each of the front and rear, and three cameras may be provided on each of the left and right sides, so a total of eight cameras may be provided on the trailer vehicle.

Meanwhile, since the purpose of using the plurality of cameras is to capture images to generate a surround view image, it is preferable to provide the cameras at respective positions as high as possible so that the surround view image may be generated more efficiently. For example, the camera provided on the front may be provided on an upper side of a front windshield, and the camera provided on the rear may be installed at an upper rear edge of the trailer. The cameras provided on the left and right sides may also be provided at respective edge parts of the left and right sides so that photographing directions are oriented from top to bottom.

The trailer image processing device 320 generates trailer image information on the trailer by receiving images captured by some of the cameras, which are provided on the trailer, among the plurality of cameras. The trailer image processing device is connected to some cameras provided on the trailer and may generate the trailer image information by receiving the images captured by the respective cameras.

Meanwhile, the trailer image processing device 320 may be implemented as an ECU provided in the trailer. The trailer image processing device 320 may receive images from the trailer cameras through the communication device 320a. In addition, the images may be processed as trailer image information through the calculation device 320c. In addition, the trailer image information and calibration information may be stored in the storage device 320b. The calibration information may be automatically calculated on the basis of viewpoint differences between the images received from the respective cameras, or may be input by an administrator when the trailer image processing device is installed in the trailer. In this case, the administrator's input of actual measured values for distances, directions, angles, and the like between positions where the respective cameras are provided and a position where the trailer image processing device is provided may be used as calibration information.

The tractor image processing device 330 receives the trailer image information and calibration information from the trailer image processing device, and generates tractor image information on the tractor by using images captured by some of the cameras, which are provided in the tractor, among the plurality of cameras. In addition, a surround view image is generated on the basis of the trailer image information and the tractor image information, and distortion of the surround view image is corrected according to the calibration information.

The tractor image processing device may also be implemented as an ECU and receive the trailer image information and calibration information through the communication device 330a. In addition, a surround view image may be generated on the basis of the trailer image information and the tractor image information through the calculation device 330c. The tractor image processing device 330 may include a deep learning model for generating a surround view image, and the calculation device 330c may output the surround view image by inputting two pieces of the image information to the deep learning model. The surround view image output in this way may be stored in the storage device 330b.

Meanwhile, the above-described system 300 for generating the surround view image may be implemented with a program (or an application) including an algorithm executable on a device such as a computer. The above-described program may be stored and provided in a transitory or non-transitory computer readable medium.

The non-transitory computer readable medium is not a medium such as a register, a cache, a memory, and the like for storing short-term data, but a medium for storing data semi-permanently and readable by a device. Specifically, the various applications or programs described above may be stored and provided in the non-transitory computer readable medium such as a CD, a DVD, a hard disk, a Blu-ray disk, a USB, a memory card, a read-only memory (ROM), a programmable read only memory (PROM), an Erasable PROM (EPROM) or an Electrically EPROM (EEPROM), or a flash memory.

The transitory computer readable medium refers to various random access memories (RAMs) such as a static RAM (SRAM), a dynamic RAM (DRAM), a synchronous DRAM (SDRAM), a double data rate SDRAM (DDR SDRAM), an augmented type SDRAM (i.e., an Enhanced SDRAM (ESDRAM)), a synchronized DRAM (i.e., a Synclink DRAM (SLDRAM)), and a Direct Rambus RAM (DRRAM).

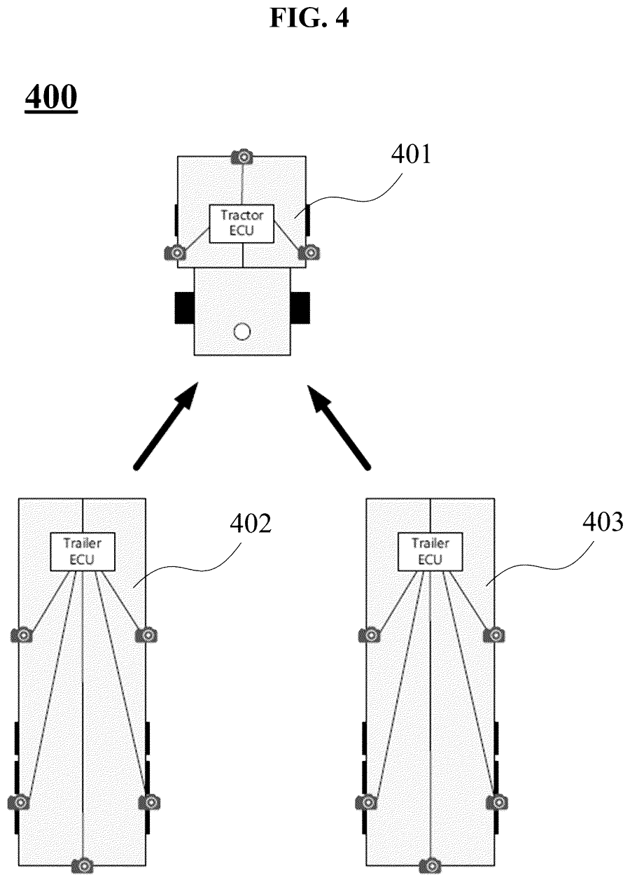

FIG. 4 is a view illustrating a case in which a trailer is connected to a tractor. FIG. 4 is an example where an ECU is an image processing device. Referring to FIG. 4, a tractor 401 may be provided with one ECU, and each of trailers 402 and 403 may also be provided with one ECU. It is assumed that the trailer 402 and trailer 403 have sizes different from each other or that the positions and/or orientations of the arranged cameras are different from each other.

Currently, the tractor 401 is connected to the trailer 402. The ECU of the tractor 401 receives trailer image information and calibration information from the ECU of the trailer 402. The ECU of the tractor 401 generates a surround view image by using the trailer image information, the calibration information, and the tractor's tractor image information.

Hereinafter, it is assumed that the tractor 401 is connected to a new trailer 403. The ECU of the tractor 401 receives new second trailer image information and new calibration information from the ECU of a newly connected trailer 403. The ECU of the tractor 401 generates a surround view image by using new second trailer image information, new calibration information, and tractor's tractor image information. Accordingly, the ECU of the tractor 401 may generate an entire surround view image without distortion by using the calibration information of the replaced trailer 403.

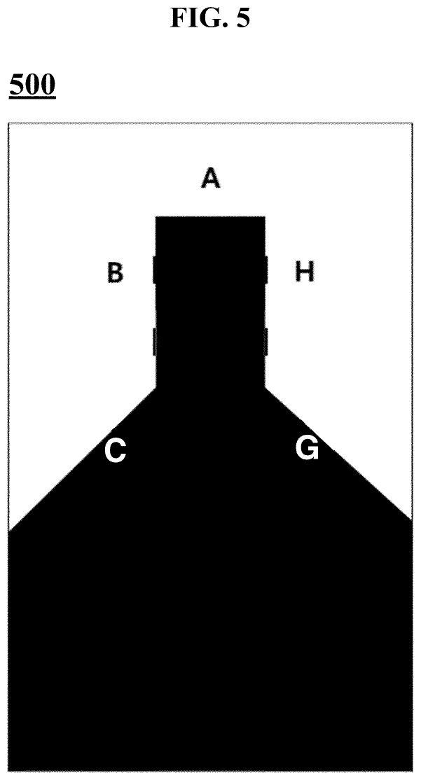

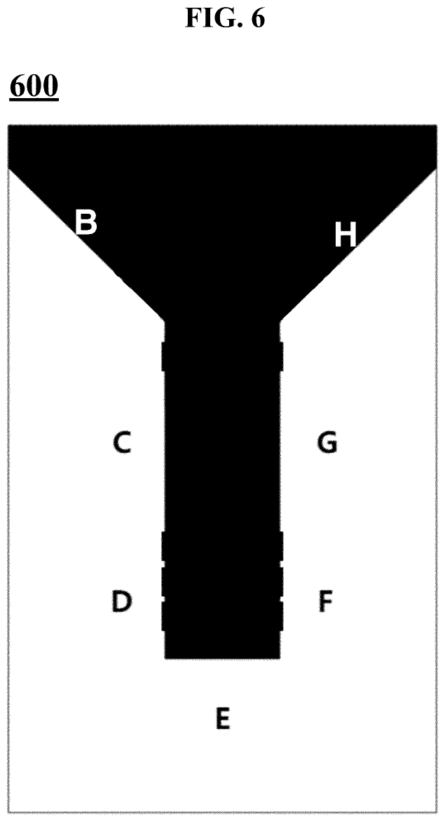

FIG. 5 is a view illustrating image information generated by an image processing device provided in a tractor. In addition, FIG. 6 is a view illustrating image information generated by an image processing device provided in a trailer. First, referring to FIG. 5, an ECU provided in the tractor may generate a surround view image of the tractor on the basis of images received from cameras provided on the tractor. For example, as shown in FIG. 5, in a case where cameras provided in the tractor are three channels, the ECU of the tractor may generate a surround view image on the basis of images of area A on the front, area B on the left, and area H on the right of the tractor.

Referring to FIG. 6, an ECU provided in the trailer may generate a surround view image of the trailer on the basis of images received from cameras provided on the trailer. For example, as shown in FIG. 6, in a case where the cameras provided on the trailer are five channels, the ECU provided on the trailer generates a surround view image on the basis of images of areas C and D on the left side, areas G and F on the right side, and area E on the rear of the tractor.

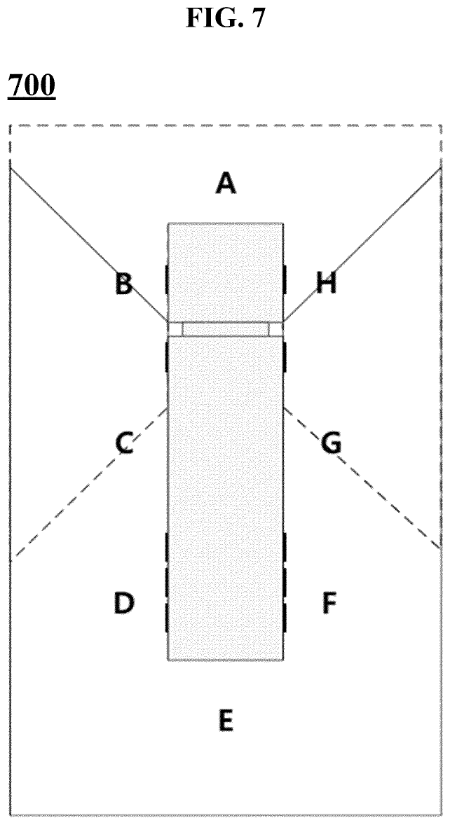

FIG. 7 is a view illustrating a synthesized surround view image. The ECU of the tractor may merge the images of FIGS. 5 and 6 to generate one surround view image.

The ECU of the tractor may synthesize the surround view image of the trailer and the surround view image of the tractor by using an image processing technology. The ECU of the tractor may synthesize the surround view image of the trailer and the surround view image of the tractor by using a pre-trained deep learning model.

Alternatively, the ECU of the tractor may generate a surround view image by using the image processing technology and synthesizing the images obtained by the trailer cameras and the images obtained by the tractor cameras. The ECU of the tractor may generate a surround view image by using the pre-trained deep learning model and synthesizing the images obtained by the trailer cameras and the images obtained by the tractor cameras.

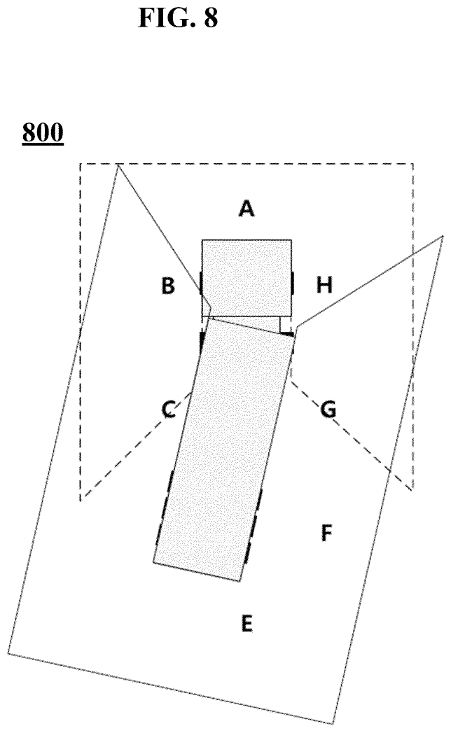

FIG. 8 is a view illustrating a surround view image when a trailer vehicle turns. As shown in FIG. 8, even in a case where the trailer vehicle turns, distortion may occur in the surround view image. The ECU of a tractor may prevent image distortion by receiving calibration information from the ECU of the trailer and reflecting a trailer turning angle included in the calibration information to the surround view image. As such, in order to calculate the turning angle when the vehicle turns, the ECU of the trailer may be connected to a sensor for calculating the turning angle, or may be additionally equipped with such a sensor. In addition, the turning angle of the vehicle may be determined by receiving detection values transmitted from the sensor at regular intervals or in real time.

Meanwhile, the ECU of the trailer may transmit image information and calibration information, which are generated by the ECU of the trailer itself, to the ECU of the tractor in real time. Accordingly, the ECU of the tractor may monitor the surroundings in real time while the vehicle is driving or being used for work.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method for generating a surround view image of a trailer vehicle, the method comprising:
receiving, by an image processing device of a tractor, first calibration information for a plurality of cameras arranged on a first trailer from an image processing device arranged on the first trailer;
receiving, by the image processing device of the tractor, first trailer image information comprising images captured by the plurality of cameras of the first trailer from the first trailer;
generating, by the image processing device of the tractor, tractor image information comprising images captured by a plurality of cameras arranged on the tractor; and
generating, by the image processing device of the tractor, the surround view image of the trailer vehicle using the first trailer image information, the tractor image information, and the first calibration information.

2. The method of claim 1, wherein the image processing device of the tractor is an electronic control unit (ECU) arranged on the tractor, and the image processing device of the trailer is an ECU arranged on the trailer.

3. The method of claim 1, wherein the image processing device of the tractor generates the surround view image by using a deep learning model.

4. The method of claim 1, wherein the calibration information comprises an arranged position, a photographing angle, and a photographing direction for each of the plurality of cameras arranged on the trailer.

5. The method of claim 4, wherein the calibration information further comprises a turning angle of the first trailer, and
the image processing device of the tractor further uses the turning angle to generate the surround view image.

6. The method of claim 1, further comprising:
receiving, by the image processing device of the tractor from an image processing device arranged on a second trailer, second calibration information for a plurality of cameras arranged in the second trailer and second trailer image information of trailer comprising images captured by the plurality of cameras arranged in the second trailer; and
generating, by the image processing device of the tractor, the surround view image for the trailer vehicle by using the first trailer image information, the second trailer image information, and the second calibration information,
wherein the tractor is connected to the new second trailer.

7. The method of claim 1, wherein the first trailer image information comprises a surround view image of the first trailer or the images captured by the plurality of cameras of the first trailer.

8. A system for generating a surround view image for a trailer vehicle, the system comprising:
a plurality of cameras arranged on a first trailer;
a trailer image processing device arranged on the first trailer, and configured to generate first trailer image information for the first trailer by receiving images captured by the plurality of cameras of the first trailer and store first calibration information for the plurality of cameras;
a plurality of cameras arranged on a tractor; and
a tractor image processing device arranged on the tractor, and configured to
receive the first trailer image information and the first calibration information from the trailer image processing device, and
generate the surround view image of the trailer vehicle using the first trailer image information and the first calibration information, and tractor image information generated by using images captured by the plurality of cameras of the tractor.

9. The system of claim 8, wherein the trailer image processing device is an electronic control unit (ECU) arranged on the trailer, and
the tractor image processing device is an ECU arranged on the tractor.

10. The system of claim 8, wherein the calibration information comprises an arranged position, a photographing angle, and a photographing direction for each of the plurality of cameras arranged on the trailer.

11. The system of claim 10, wherein the calibration information further comprises a turning angle of the first trailer, and
the tractor image processing device further uses the turning angle to generate the surround view image.

12. The system of claim 8, wherein the tractor is connected to a new second trailer, and
the tractor image processing device configured to
receives, from an image processing device arranged on the second trailer, second calibration information for a plurality of cameras arranged in the second trailer and second trailer image information comprising images captured by the plurality of cameras arranged on the second trailer and
generates a new surround view image for the trailer vehicle by using the first trailer image information, the second trailer image information, and the second calibration information.
